(19) United States
(12) Patent Application Publication
(10) Pub. No.: US 2008/0110167 A1
(43) Pub. Date: May 15, 2008

(54) Combined Relief and Positive Surge Protection Device For Operating Fluid Containers That Can Be Put Under Pressure In Operating Fluid Supply Systems of Hydrodynamic Machines

(75) Inventors: Dieter Laukemann, Vellberg (DE); Karl Mondorf, Crailsheim (DE); Werner Adams, Crailsheim (DE); Achim Neher, Crailsheim (DE); Heinz Holler, Crailsheim (DE); Jurgen Wolf, Rot Am See (DE)

Correspondence Address: Brian J Lum;Ice Miller, 200 West Madison Street, Suite 3500, Chicago, IL, 60606, US

(73) Assignee: VOITH TURBO GMBH & CO. KG, Heidenheim (DE)

(21) Appl. No.: 11/791,744

(22) PCT Filed: Nov. 21, 2005
(86) PCT No.: PCT/EP05/12433

§ 371 Date: May 25, 2007

(30) Foreign Application Priority Data
Nov. 26, 2004 (DE) 10 2004 057 375.1

(51) Int. Cl. F16D 31/02

(52) U.S. Cl. 60/468

(57) ABSTRACT

The invention concerns a combined relief and positive surge protection device for operating fluid containers that can be put under pressure in operating fluid supply systems of hydrodynamic machines
with a housing;
with an inlet chamber that can be coupled to the inner space of the operating fluid container and an outlet chamber that can be coupled to a relief space;
with a relief valve that comprises a valve component that is supported in the housing in such a way that it can be displaced, and a valve seat that is arranged stationary in the housing, whereby the valve seat is arranged in such a way that it, in cooperation with the valve component, blocks the connection between the inlet chamber and the outlet chamber;
with an actuation mechanism that is assigned to the valve component; with a positive surge protection device comprising a positive surge plate that can be guided outside the housing on a guidance element that is connected to the valve component, whereby the guidance element contains, on its end region that is opposite from the valve component, a limit stop for the motion of the positive surge plate.
with a seat on the housing that, in cooperation with the positive surge plate, closes the inlet chamber, whereby at least one throttle point is provided between the positive surge plate and the guidance element.

The invention concerns a combined relief and positive surge device for an operating fluid container that can be put under pressure in operating fluid supply systems of hydrodynamic machines; and, in addition, an operating fluid supply system of hydrodynamic machines.

Hydrodynamic machines in the form of hydrodynamic couplings, hydrodynamic retarders, or hydrodynamic rotational speed-/torque converters, are known from the state of the art in a multitude of implementations. All have in common that flow forces are used for the realization of a certain function. The hydrodynamic components are switched on or off by the filling and emptying of the bladed work wheel with an operating fluid when used in vehicles or installations with strongly varying operation. In particular, hydrodynamic retarders, which comprise a primary wheel that functions as a rotor blade wheel and a, preferably stationary, secondary wheel that functions as a stator blade wheel, are filled and emptied by the generation of a static pressure on an operating fluid level. For this the operating fluid supply system contains an operating fluid container in which the operating fluid is contained, whereby the operating fluid container in each case is connected to at least one intake in the work space of hydrodynamic retarders and at least indirectly to an outlet out of the work space. When the operating fluid container is put under pressure, the operating fluid is pressed more or less into the work space. At the same time, during the operation according to the circumstances, in particular, the rotational speed of the rotor paddle wheel and/or the available outlets from the work space and the ducting, a certain operating fluid circulation sets in during the operation of hydrodynamic retarders, whereby said process preferably takes place with the inclusion of the operating fluid container. The operating fluid container is relieved for the emptying of the hydrodynamic retarders, i.e., the evacuation of the operating fluid from the work space of the hydrodynamic retarder thereby takes place in essence through the rotor paddle wheel rotation via the connection between the outlet and the operating fluid container. The relieving of the operating fluid container in general takes place via a relief device, preferably in the form of a valve, which is arranged in between the relief chamber and the inner chamber of the operating fluid container, and which, according to need, either interrupts or, at least partly, opens the connection between the relief chamber and the inner chamber of the operating fluid container. In general, for the application of an overpressure on the operating fluid level, the operating fluid container is assigned a pressure fluid supply system, which comprises at least a pressure fluid source that is connected to the inner chamber of the operating fluid container, and whereby the connection preferably takes place in the region that is free from operating fluid, i.e., above the operating fluid level. In particular, the emptying process is accomplished by the relaxation in the operating fluid container as well as by the utilization of the rotor paddle wheel rotation. However, more oil is thereby brought back into the operating fluid container than previously has entered because of a rise in temperature, in addition, because of the direct contact of the operating fluid with air, air ends up in the solution and it leads to an undesired foam production, in particular bubble formation. First of all, this would lead more or less to the built up of so-called air cushions in the operating fluid container in the case that multiple breaking processes follow each other, which in turn leads to that only a diminished breaking effect is achieved in the case that the pressurization of the operating fluid level remains the same. In addition, the bubble formation is very disadvantageous exactly in the case of multiple, each other following, breaking processes, which are characterized by the necessary alternating between the emptying and the filling of the work space, since it is further magnified because of the introduction of air and, in addition, thereby an operating fluid-air mixture can also reach the relief system, which in certain circumstances can lead to the complete interruption of the functioning, in particular when the same line connections as those for the pressure application are used for the relief.

The invention therefore sets out to address the task to create possibilities to keep the conditions in the operating fluid tank as stable as much as possible during and after the occurring relief of a hydrodynamic machine, whereby an adjustment of a stable operating fluid level is achieved as fast as possible. Furthermore, bubble formation must be avoided at large and, as fast as possible, relief of the inner chamber of the operating fluid container can take place during the desired emptying of the hydrodynamic machine, whereby the systems that are connected to it are protected against unnecessary inlet of operating fluid. The solution according to the invention must distinguish itself thereby by as simple and economical a design as possible.

The solution according to the invention is characterized by the features of claim 1. Advantageous embodiments are represented in the subclaims. The operating fluid supply system according to the invention is described in claim 11.

According to the invention an operating fluid container that can be put under pressure is assigned a combined relief and positive surge protection device. It includes a housing. Furthermore, at least one inlet chamber that can be coupled to the inner chamber of the operating fluid container, and a relief chamber that can be coupled to an outlet chamber, are provided. The inlet and outlet chamber is assigned a relief valve comprising a valve component that can be led into the housing, and a stationary valve seat, whereby the valve seat is arranged in the housing in such a way that it cuts off, in cooperation with the valve component, the inlet chamber from the outlet chamber. In addition, the relief and positive surge device comprises a positive surge protection device. It contains a positive surge plate which can be guided on a guidance element outside the housing, whereby the guidance element is connected with the valve component of the relief valve and extends through the inlet chamber and which contains, on its end region that is opposite from the valve component, a limit stop for the motion of the positive surge plate. In addition, the positive surge plate is assigned a seat for the blocking of the inlet chamber. At least one throttle point is provided in between the positive surge plate and the guidance element. The valve component is assigned an actuation mechanism.

The solution according to the invention makes a functional integration of the function of a relief valve and a positive surge protector in a structural unit possible, whereby said integration takes place with the smallest cost by using the same elements. However, both functions are thereby adjusted to each other as regards their activation, which in particular takes place through the coupling of the guidance element for the positive surge plate to the motion of the valve component. An integration of both functions with the least construction space is also made possible by the direct assignment of the valve component and positive surge plate to the inlet chamber, whereby however, is assured nevertheless that the function of the positive surge plate can be freely realized according to the, itself adjusting, pressure ratio.

The housing is preferably implemented as a cylinder so that the valve component is also implemented as a cylinder. In particular, because of this design, a simple sealing at the valve seat is possible by utilizing standard sealing elements, for example, in the form of sealing rings. In addition, the guidance element is also implemented as a cylinder so that also under the action of forces always an optimal guidance, without tilting, of the positive surge plate is assured. Other profiles are also theoretically conceivable. However, these could lead to tilting, in particular with regard to the pressure ratios which not always adjust themselves uniformly at the positive surge plate on the front side that faces away from the housing.

The actuation mechanism for the valve component can also be implemented differently. The valve component is constructed as a piston element in the simplest case. It can be pressurized with pressure fluid on the front side that faces away from the valve seat. Hereto a control pressure chamber is provided in the housing which can be pressurized through a corresponding connection with the necessary control pressure. This can take place hydraulically or pneumatically. In order not to impede the flow through the valve and to assure an automatic resetting of the piston element, a projection is provided on the side of the valve component, i.e., the piston element, that is opposite from the valve seat, which extends through a corresponding aperture in a partition wall in the housing, and supports a projection that forms a limit stop surface at the end region that is opposite from the valve component, whereby this limit stop surface supports itself via a spring device on the housing, in particular, the partition wall. This makes an automatic resetting possible when pressure builds up in the pressure chamber. The individual lengths of the projection, the valve component, in particular, the piston element, are chosen in such a way that in the relieved state the relief valve of this combined installation is open and thereby opens, at least partly, the connection between inlet chamber and outlet chamber. Precisely when utilized in vehicles, one can rely on systems, that are available in any case, for the actuation of the combined relief and positive surge protection device for actuation, here, in particular, pressure systems. The utilization of other actuation mechanisms would also be conceivable but requires a corresponding control expenditure.

As has already been pointed out, the guidance element and the positive surge plate are preferably constructed as cylinders. The throttle point between the guidance element and the positive surge plate is thereby preferably realized by the clearance between the outer circumference of the guidance element and the inner circumference of the aperture through the positive surge plate. Thereby a ring shaped throttle gap arises which makes a uniform transfer of the mixture of operating fluid and air possible.

The guidance element is constructed according to an advantageous embodiment as a grooved stud, i.e., it contains, already on the basis of its construction, a limit stop surface. This grooved stud is connected to the valve component in such a way that it can be removed. In the case that the valve component is formed by a piston element, which is preferably implemented as a cylinder, then the grooved stud is connected to it in the region of the front side of the piston element that faces the inlet chamber. However, the arrangement preferably always takes place, in the case of an embodiment as a cylindrical element, on a common axis, i.e., the piston element, the grooved stud, and the positive surge plate are characterized by a common symmetry axis.

The housing of the combined relief and positive surge protection device can be constructed in one piece. However, it preferably consists of at least two parts that are pressure-tight connected to each other. The inlet chamber is thereby preferably constructed from an end piece that is connected to the main housing part that supports the connection for the outlet chamber, whereby the valve seat is arranged, preferably in the region of the connection.

The combined relief and positive surge protection device is in the simplest case arranged as a 2/2 directional valve with an additional positive surge protection function, whereby the positive surge plate is assigned to the inlet chamber. Further modifications of the valve installation are also conceivable, which, however, would again further complicate matters as regards the structural implementation.

The combined relief and positive surge protection device according to the invention, is arranged in operating fluid supply systems of hydrodynamic machines. The combined relief and positive surge protection device according to the invention, is thereby arranged between an operating fluid container that can be put under pressure and a relief chamber. For the relief chamber it can thereby involve, in the environment or another in the installation or the vehicle provided, a functional space that can be pressurized with pressure. The valve installation is thereby arranged in such a way that it is provided either in the connection line or the connection channel, whereby it then needs to be observed that the positive surge plate is also positioned in these or also can extend partly into the operating fluid container, for example, when the possibility for screwing in such a valve in the housing wall of the operating fluid container is provided.

The operating fluid supply system of a hydrodynamic machine that comprises at least a primary wheel and a secondary wheel, which comprise a work space that can be filled with operating fluid, comprises, in addition to the operating fluid container, connection lines between the operating fluid container and at least one inlet in the work space and at least one outlet from the work space and the operating fluid container. The operating fluid container is pressurized for the generation of the necessary operating fluid pressure for the filling of the hydrodynamic component, in particular the work space of the hydrodynamic component. It is therefore assigned a pressure fluid supply system comprising at least one pressure fluid source that is connected to the inner space of the operating fluid container. The operating fluid container itself is constructed in such a way that it, for the purpose of the filling, may be moved into a pressure-tight state. For the purpose of the relieving, the operating fluid container is coupled to an relief space that can be a component of the pressure fluid supply system or also formed by a separate relief space, which also is available somewhere else in the machine. According to the function assignment to the primary wheel and the secondary wheel, the hydrodynamic machine can be constructed as a hydrodynamic retarder, a hydrodynamic coupling, or a hydrodynamic rotational speed/torque converter. In particular, such a system for the purpose of the realization of a fast filling and emptying finds application in hydrodynamic retarders. Conceivable also is the utilization in hydrodynamic couplings, in particular, controllable and adjustable hydrodynamic couplings. In the following the functioning mode is explained by fluid of a particularly preferred application when utilized in the operating fluid supply system of hydrodynamic retarders. The combined relief and positive surge protection device is thereby in the closed state for the purpose of the filling, i.e., the inlet channel that is coupled to the inner space of the operating fluid container is sealed pressure-tight with respect to the outlet chamber, i.e., the connection is blocked. Accordingly, the necessary pressure can be brought into the inner space of the operating fluid container via the pressure fluid supply system, in particular the pressure fluid source, which, on the basis of its effect on the operating fluid level, pressurizes the operating fluid in the work space of the retarder. This is also supported by the rotor paddle wheel rotation. A work cycle thereby builds up whereby, furthermore, in addition to the work cycle in the work space, an operating fluid circulation sets in during the operation, which is characterized by the guidance outside the work space of the operating fluid from the work space again back to the work space. This takes place above all for cooling purposes. It is necessary to bring the operating fluid again into the operating fluid container in the case that the retarder is taken out of operation. It is thereby relieved. The combined relief and positive surge protection device is actuated, in particular, the relief valve is opened. In the simplest case this process thereby takes place through a lowering of the pressure in the pressure chamber of the combined relief and positive surge protection device, which causes the valve component to be lifted off the valve seat and as a result the connection between the inlet chamber and the outlet chamber is reestablished. However, the positive surge plate is at the same time, on the basis of the impulse and correspondingly the available ratio in the inner chamber of the operating fluid container, moved in the direction of the housing with its front side that faces the housing, and it comes to rest at the seat that is therefore provided in the housing. This means that the positive surge plate blocks the entry to the inlet chamber in this state. In particular when a mixture of operating fluid and air is led into the operating fluid container, a part arrives via the throttle gap in the inlet chamber and builds up a counter pressure on surface of the positive surge plate that faces toward the housing. If, because of the effect of the force of gravity, the resulting pressure in the case of a vertical installation is larger than that on the front side of the positive surge plate that faces away from the housing, then it falls downwards and opens the connection between the operating fluid inner space and the inlet chamber. The combined relief and positive surge protection device thereby prevents the fast transfer of the mixture of operating fluid and air in the relief space and serves the quieting of the oil level as well as the flowing back of the part of operating fluid that arrives via the throttle gap in the operating fluid container. The operating fluid is thereby again separated from the air and, in addition, the danger of a build-up of a pressure cushion in the operating fluid container is also no longer present the case of a rapid alternation between emptying and filling processes.

The solution according to the invention is clarified in the following with the aid of figures. In these the following is depicted in detail:

The size of the throttle gap is chosen in such a way that the surface ratio of the valve cross section and the gap cross section >10, very preferably is between 40 and 65.

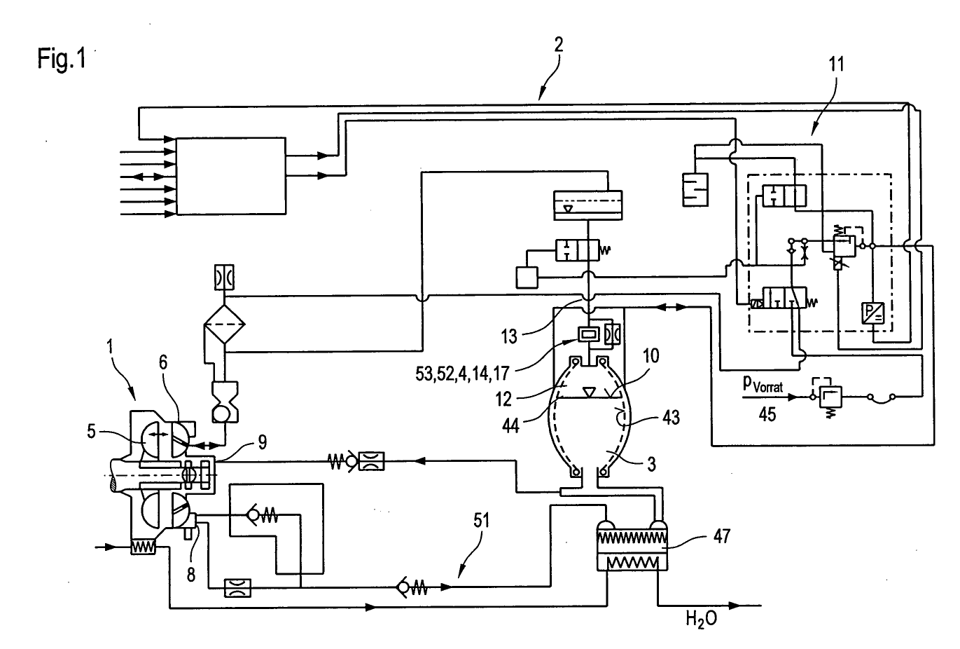

FIG. 1 clarifies in a schematically simplified representation the integration of a combined relief and positive surge protection device in an operating fluid supply system of a hydrodynamic machine, in particular in the form of a hydrodynamic retarder;

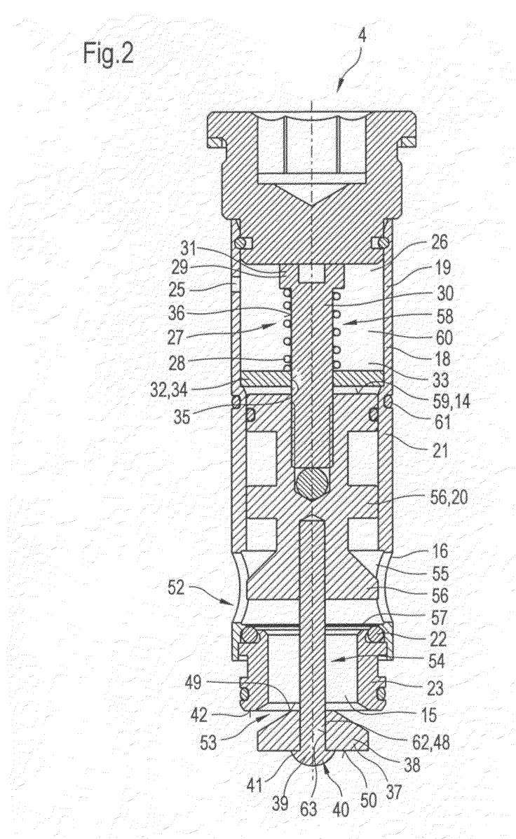

FIG. 2 clarifies in a schematically simplified representation the basic design of a particularly advantageous combined relief and positive surge protection device designed according to the invention.

FIG. 1 clarifies the arrangement and design of a combined relief and positive surge protection device 4 according to the invention in a schematically simplified representation on the basis of an operating fluid supply system 2 that is assigned to a hydrodynamic machine 1 and that comprises an operating fluid container 3. The hydrodynamic machine 1 comprises at least one primary wheel 5 and one secondary wheel 6, which form a work space 7 that can be filled with operating fluid. The hydrodynamic machine 1 can be constructed as a hydrodynamic retarder according to the bearing, connection, and arrangement, of the primary wheel 5 and the secondary wheel 6. In this case the primary wheel 5 functions as rotor and the secondary wheel 6 as stator, whereby the secondary wheel 6 is in this case mounted stationary. In the design, as a hydrodynamic coupling, the primary wheel 5 functions as bladed impeller and the secondary wheel 6 as turbine wheel, whereby the primary wheel 5 and the secondary wheel 6 are connected torque proof to a drive and an output, respectively. In addition, also conceivable is the implementation of the hydrodynamic machine 1 as a hydrodynamic rotational speed/torque converter, whereby in this case in addition at least one stator is provided.

The operating fluid supply system 2 comprises a closed operating fluid container 3 that can be pressurized, whereby said system can be connected to at least one outlet 8 from the work space 7 of the hydrodynamic machine 1, and, in addition, can be coupled to at least one inlet 9 in the work space 7 during the formation of a circulation 51. The filling and emptying of the hydrodynamic machine 1, as well as a desired control of the degree of filling, takes place through the application of a static pressure p_{static} on the operating fluid level 10 in the operating fluid container 3. The operating fluid supply system 2 comprises hereto a pressure fluid supply system 11 that is assigned to the operating fluid container 3 and that is at least connected to the inner space 12 of the operating fluid container 3. The connection to the inner chamber 12 occurs thereby in the region that is free of operating fluid in the idle state, i.e., above the highest operating fluid level 10 that occurs. In addition, the operating fluid container 3, in particular the inner space 12, is at least indirectly connected to a relief space 13. Each space with a smaller pressure level than that in the operating fluid container 3 can thereby be regarded as a relief space 13. The relief can thereby take place in the simplest case in the surroundings or, for the acceleration of the evacuation of the operating fluid from the work space 7 of the hydrodynamic machine 1, in the work space 7. The combined relief and positive surge protection device 4 is integrated in the connection between the inner space 12 and the relief space 13. The design of the combined relief and positive surge protection device 4 according to a particularly advantageous arrangement in the form of a valve installation 14, that comprises two connections, a first connection 15 and a second connection 16, preferably in the form of a 2/2 directional valve device 17 with an integrated positive surge protection function, is represented in FIG. 2. The notion ‘connection’ is thereby not to be understood as a structural, but as a functional, element. All possible connections are consequently included. This means that it hereby can involve openings, projections, or other individual elements, which comprise a coupling with connection elements to the corresponding devices—the operating fluid container 3 and/or the relief space 13. The second connection 16 is thereby connected, at least indirectly, with the relief space 13, whereas the first connection 15 is coupled to the operating fluid container 3, in particular the inner space 12. The combined relief and positive surge protection device 4 structurally unites a relief valve 52 and a positive surge protection device 53. In addition, both systems are also functionally coupled to each other due to the structural coupling. The combined relief and positive surge protection device 4 comprises a housing 18 in which an inlet chamber 54 is arranged, which can be coupled via the connection 15 to the operating fluid container 3, in particular the inner space 12, and an outlet chamber 55 that can be coupled to the relief space 13 via the second connection 16. The inlet and outlet chambers 54 and 55 are components of the relief valve 52. The relief valve 52 comprises a valve component 56 that is guided in the housing 18 in such a way that it can slide, and a stationary valve seat 57 that is arranged in such a way that it, in cooperation with the valve component, completely blocks the connection between the inlet and outlet chambers 54, 55. An actuation mechanism 58 is assigned to the valve component 56. The implementation of the combined relief and positive surge protection device 4 as a 2/2 directional valve 17 with a positive surge protection, has an essentially cylindrical construction. The housing 18 is preferably constructed as a cylinder. The housing 18 comprises, in the installed position according to FIG. 1, in the vertical direction, i.e., perpendicular, directed walls 19 which are formed, in the construction in cylindrical form, by the cylindrical housing, whereby the valve component 56 in the form of a piston element 20 is guided on it parallel to and/or along the symmetry axis. With this at least two paths are possible for the medium that flows through the valve device 52. According to a first operating position, the connection between the inlet and outlet chamber is blocked, whereas in a second operating position this connection is, at least partly, enabled. The piston element 20 thereby comes to rest on the valve seat 57 in the first operating position. In the simplest case this is formed by the housing 18, however, as represented here, a sealing element 22 is preferably provided that seals the valve seat 52 with respect to the piston element 20. The housing 18 is in the simplest case constructed in multiple parts because of assembly considerations. The inlet chamber 54 is arranged in a cylindrical end piece 23 that is torque proof connected with the main component 21 of the housing 18. However, it is also conceivable to construct them directly on the housing 18. In the represented case both the chambers 54, 55 as well as the connections 15 and 16 are oriented perpendicular to each other. However, an angle between >0 and <180 degrees or >180 degrees and <360 degrees, is also conceivable. The first connection 15, and thereby also the inlet chamber 54, is preferably oriented in the direction of gravity, i.e., in the vertical direction. This means that the axis that describes it, in the case of a cylindrical implementation, preferably coincides with the symmetry axis of the housing 18. The valve component 56 is assigned an actuation mechanism 58. This comprises a space 60 in the housing 18 that can be pressurized with pressure fluid, whereby the pressure acts on the front surface of the piston element 20 that faces away from the valve seat. It must thereby be assured that, during the pressurization of the piston element 20, the piston element 20 is guided pressure-tight, at least in the region where the pressure acts, in the housing 18. This is realized in the represented case by the implementation of the piston element 20 as a multiple piston, whereby the active surface 24 for the drive pressure is sealed, by means of a sealing device 61, with respect to the inner wall 19 of the housing 18 in the region of the piston element 20 that forms the pressure chamber 60. The piston element 20 can be pressurized with a drive pressure p_{drive} on its piston surface 59 that also forms the action area 24 for the drive pressure and that faces away from the connection 15 and thereby the inlet chamber 54. The housing 18 of the valve device 14 contains in addition a connection 25 that is realized as an aperture in the housing wall in the represented case and through which the drive pressure p_{drive} in the inner space 26 of the housing 18 can be let into the pressure chamber 60, and can act on the piston surface 59 that faces away from the connection 15. In addition, means 27 are provided for the resetting of the piston element 20 during the relief of the pressure chamber 60. In the simplest case these comprise a spring unit 28, on which the piston element 20 supports itself on the housing 18, in particular, on the housing wall 19. In addition, the piston element 20 is removably connected with an element 30 that supports a limit stop 29, whereby the limit stop 29 is formed by the end piece 31 of the element 30 that supports the limit stop and points in the direction to the piston element 20. On this limit stop 29 the spring unit 28 supports itself more or less on the piston element 20. The support on the housing 18 takes place via a projection 32 on the housing wall 19 which is thereby provided all around in the circumferential direction and forms a limit stop surface 33 for the spring unit 28 for the end region that is opposite from the limit stop 29. The projection 32 is formed, in the simplest case of a cylindrical implementation of the housing 18, by a disk element 34 that contains an aperture 35 through which the element 30 that supports the limit stop is guided, and whereby at least one clearance fit is provided in between the aperture 35 and the outer circumference 36 of the element 30 that supports the limit stop, in order to assure a frictionless guidance. On the other hand, the aperture 35 is dimensioned in such a way that a secure support of the spring unit 28 can take place.

A so-called positive surge protection device 53 is provided in order to assure precisely in hydrodynamic machines 1 an optimal functioning of the whole system during alternating emptying and refilling of the work space 7. It comprises a positive surge plate 37 that is assigned to the inlet chamber 54 and which blocks it after the opening of the relief valve 52, at least for a time duration t and at least partly, with respect to the inner space 12 of the operating fluid container 3. Preferably, the positive surge plate 37 is thereby likewise in the form of a disk 38. Said disk is guided on the valve component 56, in particular the piston element 20, whereby the guidance takes place via a guidance element, in the form of a grooved stud 39, that extends away from the piston element 20 in the vertical direction. The grooved stud 39 can be, or is, thereby connected to the piston element 20 in such a way that it can be detached and contains a limit stop 41 on its end region 40 that is opposite from the piston element 20. The limit stop 41 serves thereby for the limiting of the mobility of the positive surge plate 37 with respect to the grooved stud 39. The positive surge plate 37 is thereby, according to the installation position with vertical orientation, displaced in the vertical direction. The displacement of the positive surge plate 37 thereby takes place preferably perpendicular to the valve seat 57. The positive surge plate 37 is assigned a seat on the housing 18 that, in cooperation with the positive surge plate 37, closes the inlet chamber 54. Between the positive surge plate 37 and the guidance element at least one throttle point 62 is provided that is preferably formed by a ring-shaped gap 48 by the choice of the clearance between the outer circumference of the guidance element and the inner circumference of the aperture 63. All elements are preferably implemented as cylinders so that the valve component 56, the guidance element, and the positive surge plate 37, as well as the housing 18, have a common symmetry axis.

The mode of operation of the valve device is in an implementation according to FIG. 1 as follows: When the hydrodynamic machine 1 must be switched on, i.e., be put into operation, then the operating fluid container 3, in particular the space 44 formed between the operating fluid level 10 and the inner wall 43, is pressurized. Thereto pressure means, for example, in the form of a gaseous medium, are introduced into the space 44 via the pressure fluid supply system 11 that comprises a pressure means source 45, and they act on the operating fluid level, so that, through the connection between the operating fluid container 3 and the inlet 9 in the work space 7, operating fluid is introduced into it. A circulation sets in during normal operation, for example, in the form of a closed circulation 51 as represented in FIG. 1, and which makes the guidance of the operating fluid from the work space 7 via, for example, a cooling installation, here in the form of a heat exchanger 47, to the work space possible. In addition to the work cycle 46 in the work space 7, an additional closed operating fluid circulation sets in. The space 44 is relieved when the hydrodynamic machine 1 is now emptied. The relief thereby takes place in a relief space 13. However, it can lead to bubble formation since more oil is transferred back into the container than was brought in, which is related to the heating, and a mixture of oil and air is transferred back into the operating fluid container due to the contact with air. Since the combined relief and positive surge protection device 4 is in this state also activated, in order that the valve installation in the form of the relief valve 52 is actuated, i.e., opened, the positive surge plate 37 is displaced in the axis direction along the grooved stud 39 against the seat 42 so that it closes the inlet chamber 54, because of the impulses generated by the opening process and the overpressure that builds up in the space 44. However, since a ring-shaped gap 48, which acts as a throttle, is present between the positive surge plate 37 and the grooved stud 39 because of the clearance and/or the chosen dimensions, the pressure in space 44 can be relieved slowly, in spite of the opened relief valve 52, via the throttle into the relief space 13 because of the ring-shaped gap 48. Not only a gaseous medium in the form of air, but also a mixture of oil and air passes thereby through this gap. The positive surge plate 37 remains in the position in which it essentially closes the connection 15 until the sum of the pressure on the front side 49 of the positive surge plate 37 that faces away from the space 44 and the gravitational force of the positive surge plate, exceeds the pressure in space 44 on the front side 50 of the positive surge plate that faces toward it. The positive surge plate 37 then falls back and also the oil that arrived through the gap 48 ends up back in the space 44 and/or the inner space of the operating fluid container 3. In this way it is assured that always an almost complete relief takes place in the operating fluid container and that, in addition, a foaming of the operating fluid, which is brought into the operating fluid container at high speed, is avoided. As a result, a pressure cushion, which can negatively influence the drive processes that follow, does not build up.

### REFERENCE MARK LIST

1 hydrodynamic machine
2 operating fluid supply system
3 operating fluid container
4 combined relief and positive surge protection device
5 primary wheel
6 secondary wheel
7 work space
8 outlet
9 inlet
10 operating fluid level
11 pressure fluid supply system
12 inner space
13 relief space
14 valve device
15 first connection
16 second connection
17 2/2-directional valve
18 housing
19 wall
20 piston element
21 main component
22 sealing element
23 cylindrical end piece
24 active surface
25 connection
26 inner space
27 means for the resetting of the piston element 20
28 spring unit
29 limit stop
30 element that supports the limit stop
31 end piece
32 projection
33 limit stop surface
34 disk element
35 aperture
36 outer circumference
37 positive surge plate
38 disk
39 grooved stud
40 end region
41 limit stop
42 seat in housing
43 inner wall
44 space
45 pressure means source
46 work cycle
47 heat exchanger
48 ring-shaped gap
49 front side
50 front side
51 circulation
52 relief valve
53 positive surge protection device
54 inlet chamber
55 outlet chamber
56 valve component
57 valve seat
58 actuation mechanism
59 piston surface
60 space
61 sealing element
62 throttle point
63 aperture

1. Combined relief and positive surge device (4) for an operating fluid container (3) that can be put under pressure in operating fluid supply systems (2) of hydrodynamic machines (1).
with a housing (18);
with a relief valve (52) comprising an inlet chamber (54) that can be coupled to the inner space (12) of the operating fluid container (3), an outlet chamber (55) that can be coupled to the relief space (13) of the operating fluid container (3), a valve component (56) that is supported displaceable in the housing (18), and a valve seat (57) that is arranged stationary in the housing (18), whereby the valve seat (57) is arranged in such a way that it blocks, in cooperation with the valve component (56), the connection between the inlet chamber (54) and the outlet chamber (55).
with an actuation mechanism (58) that is assigned to the valve component (56)
with a positive surge protection device (53) comprising a positive surge plate (37) which can be guided outside the housing (18) on a guidance element that is connected with the valve component (56) of the relief valve (52), whereby the guidance element contains a limit stop (41) for the movement of the positive surge plate (37) on its end region that faces away from the valve component (56), and a seat (42) on the housing (18) that, in cooperation with the positive surge plate (37) closes the inlet chamber (54), whereby at least one throttle point (62) is provided between the positive surge plate (37) and the guidance element.

2. Combined relief and positive surge protection device (4) according to claim 1, characterized by the following features:
the positive surge plate (37) is constructed in the shape of a disk;
the guidance element has a cylindrical cross section;
The clearance between the outer circumference of the guidance element and the inner circumference of the aperture (63) at the positive surge plate (37) is dimensioned in such a way that a ring-shaped throttle gap (48) results.

3. Combined relief and positive surge protection device (4) according to claim 2, characterized by that the surface ratio of the valve cross section to the gap cross section is >10, preferably, between 40 and 65.

4. Combined relief and positive surge protection device (4) according to one of the claims 1 to 3, characterized by that the valve component (56) is formed by a piston element (20).

5. Combined relief and positive surge protection device (4) according to one of the claims 1 to 4, characterized by that the valve component (56), the housing (18), the positive surge protection plate (37), and the guidance element, possess a common symmetry axis.

6. Combined relief and positive surge protection device (4) according to claim 1 to 5, characterized by the following features:
the valve component (56) supports itself on the housing (18);
The actuation mechanism (62) comprises in the housing (18) a pressure space (60) that can be pressurized with pressure means in which the support of the valve component (56) takes place;
the pressure space (60) contains a connection (25) for the pressurization of the drive pressure;
The valve component (56) is assigned means (27) for the resetting during the relief of the pressure space (60).
the means (27) comprise an extension that contains a limit stop (29) provided on the valve component (56) on its front side that faces away from the valve component (57), and which can be guided through an aperture (35) of a partition wall in the housing (18), and which supports itself via a spring unit (28) on the front side of the partition wall that faces away from the valve seat (57).

7. Combined relief and positive surge protection device (4) according to claim 6, characterized by that the extension is formed by a cylindrical element that is detachably connected to valve component (56).

8. Combined relief and positive surge protection device (4) according to claim 7, characterized by that the extension is formed by a cylinder head screw.

9. Combined relief and positive surge protection device (4) according to one of the claims 1 to 8, characterized by that the housing (18) contains a main housing component (21) in which the valve component (56) is guided and which is connected to a separate housing component (23) that forms the inlet chamber (54).

10. Combined relief and positive surge protection device (4) according to one of the claims 1 to 9, characterized by that the length of the guidance element for the positive surge protection plate (37) is chosen as a function of the length of the inlet chamber (54), the size and dimension of the positive surge protection plate (37), the weight, as well as the theoretically occurring pressure ratios in the operating fluid container.

11. Operating fluid supply system (2) for hydrodynamic machines (1), in particular hydrodynamic retarders or hydrodynamic couplings, comprising at least one primary wheel (5) and one secondary wheel (6) that form a work space (7) that can be filled with operating fluid;
with an operating fluid container (3) that can be pressurized and closed pressure-tight.
with at least one connection line between, at least, one inlet (8) of the work space (7) and the operating fluid container (3), and with a connection line between, at least, one outlet (9) from the work space (7) and the operating fluid container (3). 11.3 with a pressure fluid supply system (11) that is connected to the inner space (12) of the operating fluid container (3) in the region that is free from operating fluid, whereby the pressure fluid generation system (11) comprises at least one pressure means source;
with at least one connection between the inner space (12) of the operating fluid container (3) and a relief space (13), whereby a combined relief and positive surge protection device (4) according to one of the claims 1 to 10 is arranged in the connection.

12. Operating fluid supply system according to claim 11, characterized by that the combined relief and positive surge protection device is installed in the vertical direction, so that the valve component can move in the vertical direction and the positive surge plate is oriented in the horizontal direction.
